(19) United States
(12) Patent Application Publication
(10) Pub. No.: US 2026/0124901 A1
(43) Pub. Date: May 7, 2026

(54) ARCHITECTURE FOR HYBRID MINING TRUCKS

(71) Applicant: Cummins Inc., Columbus, IN (US)

(72) Inventor: Kieran J. Richards, Northamptonshire (GB)

(21) Appl. No.: 18/934,822

(22) Filed: Nov. 1, 2024

(51) Int. Cl. B60K 6/40; B60K 6/24; B60K 6/28; B60K 11/04; B60K 15/03; B60K 15/063; B60L 58/24; B62D 21/02; H01M 50/204; H01M 50/249; H01M 50/258

(52) U.S. Cl. CPC B60K 6/40; B60K 6/24; B60K 6/28; B60K 11/04; B60K 15/063; B62D 21/02; H01M 50/204; H01M 50/249; H01M 50/258; B60K 2015/03118; B60L 58/24; B60L 2210/10; B60Y 2200/40; B60Y 2200/92; B60Y 2400/112; H01M 2220/20

(57) ABSTRACT

Architectures of heavy equipment vehicles, such as mining trucks, are presented herein for hybridization of such vehicles. For example, the architectures provided herein may relate to the placement of a battery pack module, a hydraulic liquid tank, a second liquid tank such as a fuel tank, and various components required for operation of a hybrid mining truck.

### TECHNICAL FIELD OF THE PRESENT DISCLOSURE

The present disclosure relates to architectures, or component arrangement, of hybrid mining trucks. In particular, the present disclosure relates to the arrangement of vehicle components for the retrofitting or first fitting of mining trucks for operation of the mining trucks using hybrid powertrain systems.

### BACKGROUND OF THE PRESENT DISCLOSURE

Environmental and efficiency considerations have resulted in the electrification of vehicles across industries and purposes. While electric and hybrid passenger and cargo vehicles are becoming more commonplace, electrification and/or hybridization of large equipment vehicles poses its own set of challenges. For example, large equipment vehicles, such as mining trucks, cranes, bulldozers, etc. may require a workload and/or have a sheer size component that make implementation of alternative powertrains more difficult. Additionally, the components required for hybridization and/or electrification of such vehicles may be difficult to arrange due to the space available relative to the respective vehicle for mounting such components.

### SUMMARY OF THE PRESENT DISCLOSURE

Architectures of heavy equipment vehicles, such as mining trucks, are presented herein for hybridization of such vehicles. For example, the architectures provided herein may relate to the placement of a battery pack module, a hydraulic liquid tank, a second liquid tank such as a fuel tank, and various components required for operation of a hybrid mining truck.

In a first aspect of the disclosure, a mining haul truck is provided. The mining haul truck includes a chassis; a first wheel coupled to a first side of the chassis at a first forward position; a second wheel coupled to the first side of the chassis at a first rearward position; a third wheel coupled to a second side of the chassis at a second forward position; and a fourth wheel coupled to the second side of the chassis at a second rear ward position. The first wheel and the second wheel define a first space therebetween. The third wheel and the second wheel define a second space therebetween. The mining truck also includes a hydraulic tank coupled to the chassis within the second space and a fuel tank coupled to the chassis within the second space.

In another aspect of the disclosure, a mining haul truck is provided. The mining haul truck includes a chassis having a first longitudinal frame member on a first side of the chassis extending from a first end of the chassis to a second end of the chassis and a second longitudinal frame member on a second side of the chassis extending from the first end of the chassis to a second end of the chassis. The first longitudinal frame member and the second longitudinal frame member define a first space therebetween. The mining truck also includes a first wheel coupled to a first side of the chassis at a first forward position; a second wheel coupled to the first side of the chassis at a first rearward position; a third wheel coupled to a second side of the chassis at a second forward position; and a fourth wheel coupled to the second side of the chassis at a second rearward position. The first wheel and the second wheel define a second space therebetween. The third wheel and the fourth wheel define a third space therebetween. The mining haul truck further includes an internal combustion engine positioned in the first space and a battery pack module coupled to the chassis within the second space.

In yet another aspect of the disclosure, a mining haul truck is provided. The mining haul truck includes a chassis supporting a deck on a forward position thereof; a resistor grid positioned in a first region associated with a first side of the deck; an operator cab positioned in a second region associated with a second side of the deck; and a DC/DC system positioned in the first region in a forward position relative to the resistor grid. The DC/DC system and the resistor grid define a space therebetween. The mining haul truck also includes a thermal management system positioned at least partially in the space.

In another aspect of the disclosure, a mining haul truck is provided. The mining haul truck includes a chassis supporting a deck on a forward portion thereof; a resistor grid positioned in a first region associated with a first side of the deck; an operator cab positioned in a second region associated with a second side of the deck; a DC/DC system positioned on the resistor grid; and a thermal management system positioned at least partially in the first region.

In yet another aspect of the disclosure, a mining haul truck is provided. The mining haul truck includes a chassis supporting a deck on a forward portion thereof; a resistor grid and a DC/DC system positioned in a first region associated with a first side of the deck; an operator cab positioned in a second region associated with a second side of the deck; and a floor space of the deck defined partially within the first region and partially within the second region, the floor space configured to receive an on-board trolley system.

In another aspect of the disclosure, a mining haul truck is provided. The mining haul truck includes a chassis supporting a deck on a forward position thereof. The deck has a first deck side corresponding with a first chassis side and a second deck side corresponding with a second chassis side. The mining haul truck also includes a battery pack module coupled to the first chassis side and a thermal management system at least partially positioned on the first deck side. The thermal management system includes a first fluid route to the battery pack module.

In yet another aspect of the disclosure, a method of assembling a mining haul truck is provided. The mining haul truck includes a chassis, a first wheel and a second wheel mounted to a first side of the chassis, and a third wheel and a fourth wheel mounted to a second side of the chassis. The method includes mounting a hydraulic liquid tank to the chassis at a first position between the first wheel and the second wheel and mounting a second liquid tank to the chassis at a second position between the first wheel and the second wheel.

In another aspect of the disclosure, a method of assembling a mining haul truck is provided. The mining haul truck includes a chassis, a first wheel and a second wheel mounted to a first side of the chassis, and a third wheel and a fourth wheel mounted to a second side of the chassis. The method includes mounting a hydraulic tank to the chassis at a first position between the first wheel and the second wheel and mounting a battery pack module to the chassis at a second position between the third wheel and the fourth wheel.

In yet another aspect of the disclosure, a method of assembling a mining haul truck is provided. The mining haul truck includes a chassis, a deck supported by a forward portion of the chassis, a first wheel and a second wheel mounted to a first side of the chassis, and a third wheel and a fourth wheel mounted to a second side of the chassis. The method includes mounting a resistor grid on the deck at a first position and mounting a thermal management system on the deck at a second position forward of the resistor grid.

In various aspects of the disclosure, the mining haul truck may further include a second fuel tank positioned in the second space. The mining haul truck may further include a third fuel tank positioned in the first space.

In various aspects of the disclosure, the mining haul truck may further include a second fuel tank positioned in the first space.

In various aspects of the disclosure, the mining haul truck may further include a battery pack module coupled to the chassis in the first space.

In various aspects of the disclosure, the fuel tank may contain diesel fuel.

In various aspects of the disclosure, the hydraulic tank may be coupled to the chassis adjacent to the chassis at an interior position and the fuel tank may be coupled to the chassis adjacent to the hydraulic tank at an exterior position so that the hydraulic tank is positioned between the chassis and the fuel tank.

In various aspects of the disclosure, the mining haul truck may further include at least one fluid tank coupled to the chassis within the third space. The at least one fluid tank may include a hydraulic tank and a fuel tank.

In various aspects of the disclosure, the battery pack module may be coupled to a thermal management system and a DC/DC system. The thermal management system and the DC/DC system may be supported by the chassis on a forward position thereof.

In various aspects of the disclosure, the battery pack module and the first wheel may define a first clearance area therebetween.

In various aspects of the disclosure, the battery pack module and the second wheel may define a second clearance area therebetween.

In various aspects of the disclosure, the battery pack module may include a plurality of battery pack layers in a vertical arrangement. Each battery pack layer of the plurality of battery pack layers may include at least one battery pack.

In various aspects of the disclosure, the mining haul truck may further include a radiator mounted on a first end portion of the chassis adjacent a first end of the chassis.

In various aspects of the disclosure, the mining haul truck may further include an inverter cabinet positioned at a rearward position of the deck. The inverter cabinet may be positioned partially in the first region and partially in the second region.

In various aspects of the disclosure, the deck may define a space at a forward position configured to receive an on-board trolley system.

In various aspects of the disclosure, the thermal management system may be fluidly coupled to the DC/DC system.

In various aspects of the disclosure, the mining haul truck may further include a radiator positioned at a full forward position of the deck.

In various aspects of the disclosure, the thermal management system may be fluidly coupled to a battery pack module. The battery pack module may be coupled to the chassis between a first wheel and a second wheel. The first wheel and the second wheel may both be positioned on a first side of the chassis.

In various aspects of the disclosure, the thermal management system may be positioned at a forward position relative to the resistor grid.

In various aspects of the disclosure, the DC/DC system may be in a forward position relative to the resistor grid. The thermal management system may be positioned at least partially between the DC/DC system and the resistor grid.

In various aspects of the disclosure, the mining haul truck may further include a hydraulic liquid tank coupled to the second chassis side. The mining haul truck may further include a second liquid tank coupled to the second chassis side. The second liquid tank may be a fuel tank.

In various aspects of the disclosure, the mining haul truck may further include a DC/DC system positioned on the first deck side. The thermal management system may include a second fluid route to the DC/DC system.

In various aspects of the disclosure, the thermal management system may be in a rearward position relative to the DC/DC system.

In various aspects of the disclosure, the mining haul truck may further include a resistor grid in a rearward position relative to the DC/DC system.

In various aspects of the disclosure, the mining haul truck may further include a resistor grid positioned beneath the DC/DC system.

In various aspects of the disclosure, the method may include mounting a third liquid tank to the chassis at a third position between the third wheel and the fourth wheel.

In various aspects of the disclosure, the method may include mounting a vehicle subsystem at a third position between the second wheel and the fourth wheel. The vehicle subsystem may be at least one of an aftertreatment system and an exhaust muffler.

In various aspects of the disclosure, the hydraulic liquid tank may be mounted to the chassis between the chassis and the second liquid tank.

In various aspects of the disclosure, the method may further include mounting a second liquid tank to the chassis at a third position between the first wheel and the second wheel.

In various aspects of the disclosure, the method may further include coupling the battery pack module toa thermal management system and a DC/DC system. The thermal management system and the DC/DC system may be supported by a deck. The deck may be supported by the chassis on a forward position thereof.

In various aspects of the disclosure, the method may further include mounting a vehicle subsystem between the second wheel and the fourth wheel. The vehicle subsystem may be an aftertreatment system.

In various aspects of the disclosure, the method may further include mounting a DC/DC system in a forward position relative to the resistor grid. Mounting the DC/DC system in the forward position relative to the resistor grid may include mounting the DC/DC system in a forward position relative to the thermal management system.

In various aspects of the disclosure, the method may further include mounting a DC/DC system on top of the resistor grid.

In various aspects of the disclosure, the method may further include fluidly coupling the thermal management system to a battery pack module. The method may further include mounting the battery pack module to the chassis at a first position between the first wheel and the second wheel.

In various aspects of the disclosure, the method may further include mounting an on-board trolley system to the deck.

Additional features and advantages of the present disclosure will become apparent to those skilled in the art upon consideration of the following detailed description of the illustrative embodiments exemplifying the disclosure as presently perceived.

### BRIEF DESCRIPTION OF THE DRAWINGS

The detailed description of the drawings particularly refers to the accompanying figures in which:

FIG. 1 is a schematic top-down illustration of an architecture arrangement of components of a mining truck;

FIG. 2 is a perspective view illustration of an exemplary chassis and components mounted thereon;

FIG. 3 illustrates a schematic top-down illustration of another architecture arrangement of components of a mining truck;

FIG. 4 illustrates a schematic side view illustration of the architecture arrangement of FIG. 3;

FIG. 5 illustrates a second schematic side view illustration of the architecture arrangement of FIG. 3;

FIG. 6 illustrates a top-down schematic illustration of a battery pack module relative to a chassis and a plurality of wheels of a mining truck with the plurality of wheels in a first configuration;

FIG. 7 illustrates a top-down schematic illustration of the battery pack module of FIG. 6 with the plurality of wheels in a second configuration;

FIG. 8 illustrates a top-down schematic illustration of another architecture arrangement of components of a mining truck;

FIG. 9 illustrates a top-down schematic illustration of an arrangement of zones on a deck of a mining truck;

FIG. 10 illustrates a side view schematic illustration of an architecture arrangement of a mining truck including a trolley system; and

FIG. 11 is an illustration of a mining truck including a trolley system.

Although the drawings represent embodiments of various features and components according to the present disclosure, the exemplification set out herein illustrates an embodiment, and such an exemplification is not to be construed as limiting the scope of the disclosure in any manner.

### DETAILED DESCRIPTION OF THE DRAWINGS

For the purposes of promoting an understanding of the principles of the present disclosure, reference will now be made to the embodiments illustrated in the drawings, which are described herein. The embodiments disclosed herein are not intended to be exhaustive or to limit the invention to the precise form disclosed. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of principles in the invention which would normally occur to one skilled in the art to which the invention relates.

The terms “couples”, “coupled”, “coupler” and variations thereof are used to include both arrangements wherein the two or more components are in direct physical contact and arrangements wherein the two or more components are not in direct contact with each other (e.g., the components are “coupled” via at least a third component), but yet still cooperate or interact with each other.

In some instances throughout this disclosure and in the claims, numeric terminology, such as first, second, third, fourth, etc., is used in reference to various components of features. Such use is not intended to denote an ordering of the components or features. Rather, numeric terminology is used to assist the reader in identifying the components or features being referenced and should not be narrowly interpreted as providing a specific order of components or features.

While the disclosure herein is provided in terms of a “mining truck”, it is understood that the features described herein may apply to other vehicles, including heavy equipment such as cranes, bulldozers, excavators, etc., locomotives, and other appropriate vehicles.

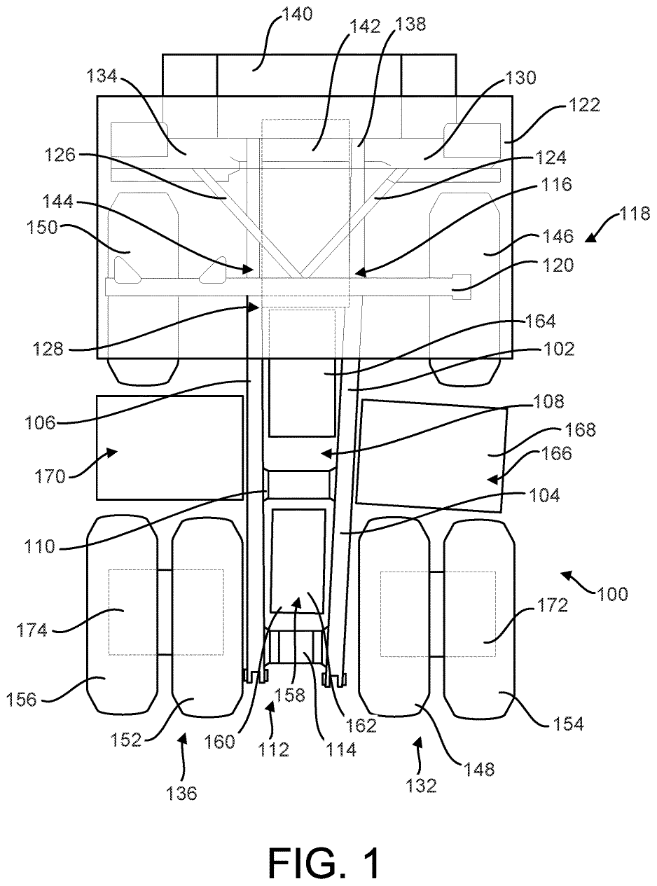

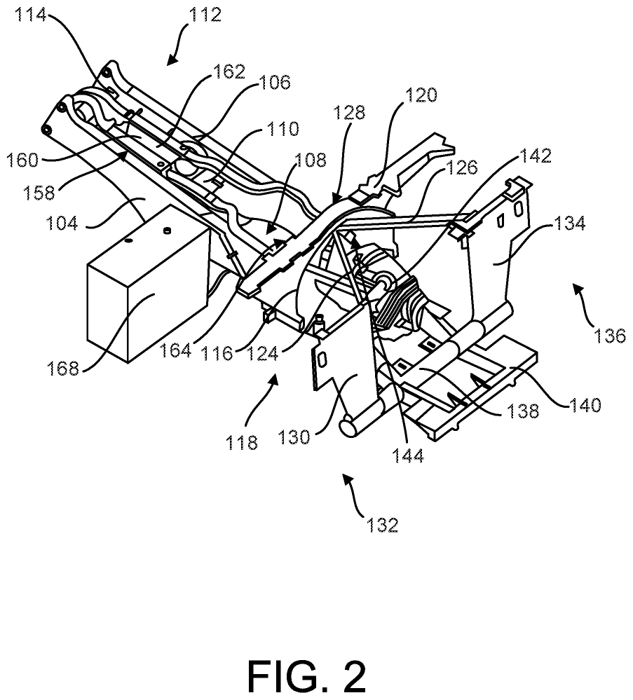

A schematic architecture of an exemplary mining truck 100 is illustrated in FIG. 1. As shown, mining truck 100 may be generally built on and/or around chassis 102. Referring additionally to FIG. 2, chassis 102 may include a first frame member 104 and a second frame member 106 extending longitudinally from a first end portion of the chassis, including a first end of the chassis, to a second end portion of the chassis, including a second end of the chassis, to at least partially define a length of mining truck 100. First frame member 104 and second frame member 106 may be spaced apart to form a space 108 therebetween, with a central crossbeam 110 extending from first frame member 104 to second frame member 106 across space 108, generally defining a rear chassis region 112. A rear crossbeam 114 may extend from first frame member 104 to second frame member 106 across space 108 at the rear of chassis 102, and a horse collar 116 may connect first frame member 104 and second frame member 106 within a forward region 118 of chassis 102.

A third frame member 120 may extend across the top of horse collar 116 and beyond the diameter of horse collar 116 to form a support for a deck 122 (FIG. 1) as described further herein. A first supplemental frame member 124 and a second supplemental frame member 126 may each extend diagonally from a central portion 128 of third frame member 120 above horse collar 116 in opposite directions so that first supplemental frame member 124 may connect to a first support plate 130 and second supplemental frame member 126 may connect to a second support plate 134. First support plate 130 may also connect to first frame member 104 on a first side 132 of chassis 102, and second support plate 134 may also connect to second frame member 106 on a second side 136 of chassis 102.

A forward crossbeam 138 may extend from first frame member 104 to second frame member 106 in general alignment with first support plate 130 and second support plate 134. A support extension 140 may extend forward of forward crossbeam 138. An engine 142 may be positioned within an opening 144 defined by horse collar 116. A traction alternator and/or gearbox may be mounted rearward of engine 142 within area 164.

Referring again to FIG. 1, wheels 146, 148, 150, and 152 may be mounted to chassis 102 via respective axles (not shown). For example, as shown, first wheel 146 may be mounted at a forward position in forward region 118 on first side 132 of chassis 102. Second wheel 148 may be mounted at a rearward position in rear region 112 on first side 132 of chassis 102. Third wheel 150 may be mounted at a forward position in forward region 118 on second side 136 of chassis 102. Fourth wheel 152 may be mounted at a rearward position in rear region 112 on second side 136 of chassis 102. In some embodiments, mining truck 100 may include a fifth wheel 154 mounted adjacent to second wheel 148 at a rearward position in rear region 112 on first side 132 of chassis 102. Some embodiments may additionally include a sixth wheel 156 mounted adjacent to fourth wheel 152 at a rearward position in rear region 112 on second side 136 of chassis 102. First wheel 146 and third wheel 150 may be mounted at a position generally corresponding to third frame member 102.

A rear region space 158 defined between first frame member 104 and second frame member 106 within rear chassis region 112, and at least partially defined between second wheel 148 and fourth wheel 152, may be sized and shaped to receive a vehicle subsystem 160. For example, as shown in FIG. 2, vehicle subsystem 160 may include an aftertreatment system 162. In other embodiments, vehicle subsystem 160 may include a battery module, a fuel tank, a powertrain support subsystem, an exhaust muffler, an exhaust silencer, or any other vehicle subsystems necessary or otherwise desired for operation of mining truck 100. As described herein, an exhaust muffler and an exhaust silencer may be similar or the same components intended to quiet an exhaust by some volume. In other embodiments, rear region space 158 may be free of any vehicle subsystems or components.

First wheel 146 and second wheel 148 may define a space, or first side saddle 166 therebetween. In some embodiments, as illustrated in FIGS. 1-2, a fuel tank 168 may be mounted to chassis 102 within first side saddle 166. Fuel tank 168 may contain, for example, diesel fuel or an alternative fuel, e.g., ammonia, methanol, ethanol, or other fuels suitable for operation of mining truck 100. Likewise, third wheel 150 and fourth wheel 152 may define a space, or second side saddle 170. A first wheel motor 172 may be associated with second wheel 148 and, in embodiments including a fifth wheel, fifth wheel 154. A second wheel motor 174 may be associated with fourth wheel 152 and, in embodiments including a sixth wheel, sixth wheel 156. In some embodiments including a fifth and/or sixth wheel, each of second wheel 148, fourth wheel 152, fifth wheel 154, and sixth wheel 156 may have a separate wheel motor. In other embodiments, all of wheels 146, 148, 150, 152, 154, and 156 or wheels 146, 148, 150, 152, or any combination thereof, may be associated with a wheel motor, whether such wheel motor is designated to a single wheel or such wheel motor is shared between two or more wheels.

Still referring to FIG. 1, deck 122 may be supported by chassis 102, and, for example, by third frame member 120, first support plate 130, and second support plate 134. In other words, deck 122 may be supported by the first end portion of chassis 102, wherein the first end portion of chassis 102 includes a first end of chassis 102. Deck 122 may be configured to support a cab to facilitate operation of mining truck 100 and various vehicle subsystems, including hybrid powertrain subsystems and components as discussed further herein.

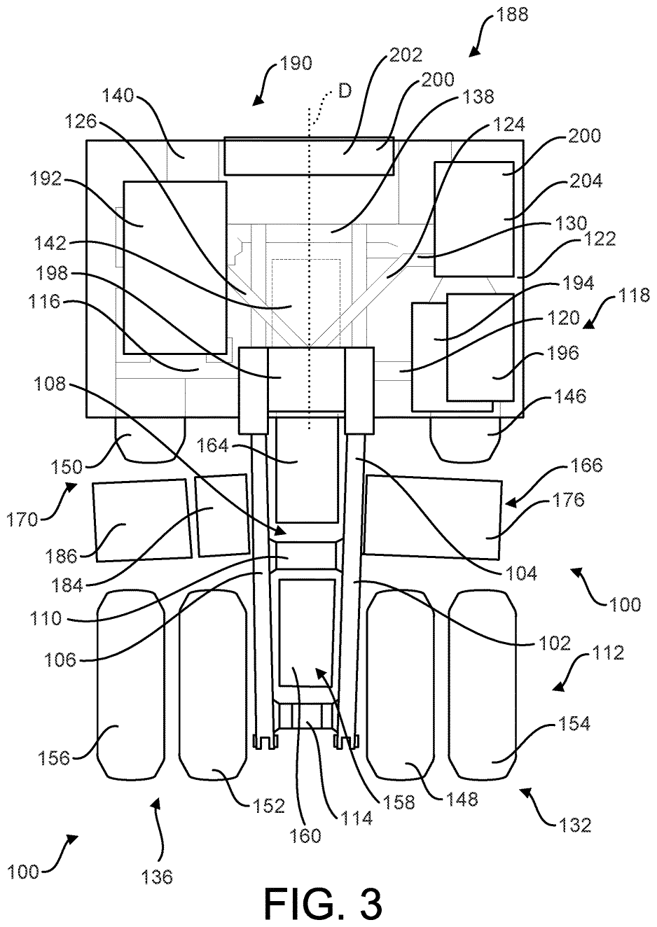

Now referring to FIGS. 3-5, a second exemplary architecture for mining truck 100 is illustrated. Mining truck 100 as illustrated in FIG. 3-5 includes the same components and details as described in relation to FIGS. 1 and/or 2 except as described further herein, with like components associated with like reference numbers.

As described above, mining truck 100 may include chassis 102 having first frame member 104 and second frame member 106. First wheel 146 may be mounted at a forward position in forward region 118 on first side 132 of chassis 102, i.e., adjacent to first frame member 104. Second wheel 148 may be mounted at a rearward position in rear region 112 on first side 132 of chassis 102, i.e., adjacent to first frame member 104, and spaced apart from first wheel 146 to define first side saddle 166 therebetween. A battery pack module 176 may be mounted to first side 132 of chassis 102 within first side saddle 166.

Battery pack module 176 may be configured to store power for use in operation of mining truck 100. In hybrid applications, battery pack module 176 may cooperate with engine 142 to provide power to wheels 146, 148, 150, 152 and, in some embodiments, wheels 154, 156 for movement of mining truck 100. Battery pack module 176 may be mounted within first side saddle 166 at a position which mitigates potential contact of any one of wheels 146, 148, 150, 152, 154 (when present) and/or 156 (when present).

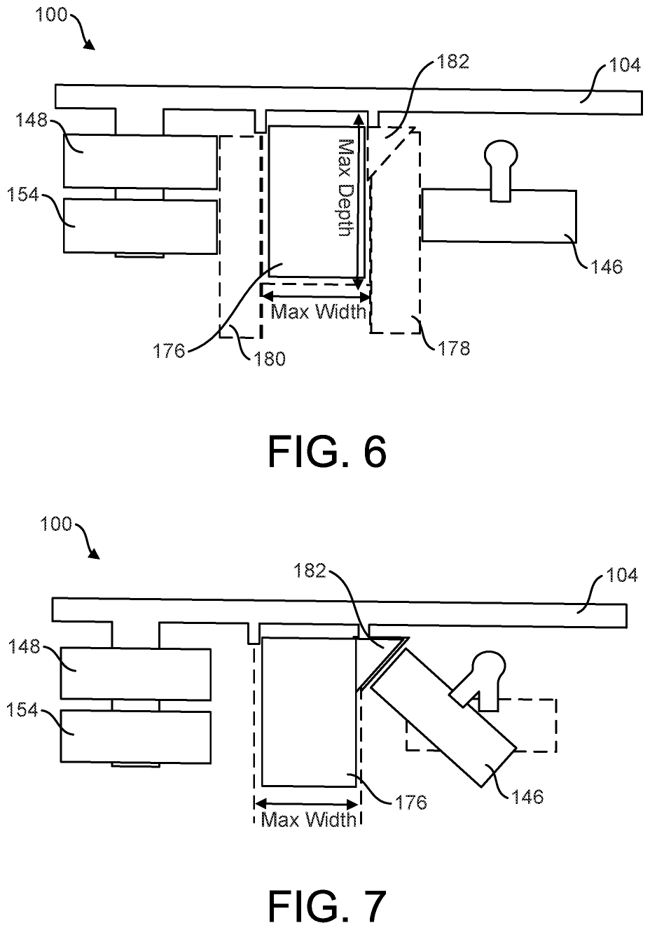

As shown in FIGS. 6-7, for example, battery pack module 176 may be mounted to chassis 102 in a manner that defines a forward access zone 178 defined between first wheel 146 and battery pack module 176 and a rearward access zone 180 defined between battery pack module 176 and second wheel 148. Forward access zone 178 and rearward access zone 180 provides clearance for movement of the wheels during operation of the mining truck, and also provides clearance for an operator, mechanic, or another person to stand within the appropriate access zone 178, 180 for access to battery pack module 176 for maintenance or other required or desired tasks.

A steering zone, or additional access zone 182, may be defined adjacent to a forward inner pocket to ensure additional clearance for the steering of first wheel 146 during operation of mining truck 100 as shown in FIG. 7. Additional access zone 182 may also provide additional clearance for the operator, mechanic, or another person to access battery pack module 176 for maintenance or other required or desired tasks. For example, in some embodiments, battery pack module 176 may be mounted to mining truck 100 (e.g., via chassis 102) in a manner so that an access to battery pack module 176 is generally positioned in or adjacent to additional access zone 182.

Mounting of battery pack module 176 within first side saddle 166 may facilitate an even balance of mining truck 100 when one or more tanks are also mounted to chassis 102 within second side saddle 170 as discussed further herein. This placement may also maximize space for battery positioning while allowing the batteries to be put in a single, unified space rather than distributed in several places over the architecture of mining truck 100. For example, in some embodiments, battery pack module 176 may include a plurality of battery pack layers in a vertical arrangement, where each battery pack layer of the plurality of battery pack layers includes one or more battery packs. This vertical arrangement of battery packs as positioned in a side saddle may take advantage of a height of mining truck 100 to include as many battery packs as necessary for efficient operation of mining truck 100 in a hybrid operation mode. While these benefits are acknowledged, it is also within the scope of this disclosure that battery pack module 176 and/or a plurality of battery packs may be alternately positioned, whether in a single, unified space (i.e., on deck 122, within rear region space 158, or another placement), or in a plurality of places throughout architecture of mining truck 100.

Referring again to FIGS. 3-5, a hydraulic liquid tank 184 may be mounted to second side 136 of chassis 102 within second side saddle 170. Hydraulic liquid tank 184 may serve as a reservoir for containing excess hydraulic fluid for operation of mining truck 100 and/or serve to hold a supply of hydraulic fluid for operation of mining truck 100. A second liquid tank 186 may be mounted to chassis 102 within second side saddle 170. In some embodiments, second liquid tank 186 may be a fuel tank.

As illustrated, hydraulic liquid tank 184 may be mounted to chassis 102 at an interior position of second side saddle 170, while second liquid tank 186 may be mounted to chassis 102 at an exterior position of second side saddle 170, so that hydraulic liquid tank 184 is substantially in-between the chassis and the second liquid tank 186. In other embodiments, hydraulic liquid tank 184 and second liquid tank 186 may be alternately arranged. For example, in some embodiments, second liquid tank 186 may be mounted to chassis 102 at an interior position of second side saddle 170, while hydraulic liquid tank 184 may be mounted to chassis 102 at an exterior position of second side saddle 170. In yet other embodiments, hydraulic liquid tank 184 and second liquid tank 186 may both be arranged at a generally interior position of second side saddle 170 so that one of hydraulic liquid tank 184 and second liquid tank 186 is positioned at a forward position near third wheel 150, and the other of the hydraulic liquid tank 184 and second liquid tank 186 is positioned at a rearward position near fourth wheel 152.

In some embodiments, a third liquid tank, for example, a second fuel tank, may be mounted to the chassis 102 within the second side saddle 170. In other embodiments, the second fuel tank may be mounted to chassis 102 within the first side saddle 166 in place of or in tandem with battery pack module 176.

Although the embodiments described above include mounting of battery pack module 176 within first side saddle 166 with hydraulic liquid tank 184 and second liquid tank 186 mounted within second side saddle 170, other arrangements may be considered that also enjoy at least some of the advantages discussed above. For example, in some embodiments, battery pack module 176 may be mounted within second side saddle 170 adjacent to hydraulic liquid tank 184 while second liquid tank 186 is mounted to chassis 102 within first side saddle 166. In other embodiments, hydraulic liquid tank 184 may remain in second side saddle 170, second liquid tank 186 may be mounted to chassis 102 within first side saddle 166, and battery pack module 176 may be mounted to deck 122.

Rear region space 158 defined by chassis 102 between second wheel 148 and fourth wheel 152 may include a vehicle subsystem 160 mounted therein, such as an aftertreatment system, a heating system for a bed of mining truck 100, and/or an exhaust muffler. In some embodiments, rear region space 158 may remain empty of any vehicle subsystems. It is within the scope of the disclosure that other subsystems beyond those listed explicitly herein may be mounted within rear region space 158.

As discussed above, deck 122 may be supported at a forward position by chassis 102. Deck 122 may include a first region 188 associated with a first side of deck 122 corresponding with first side 132 of chassis 102 and a second region 190 associated with a second side of deck 122 corresponding with second side 136 of chassis 102. First region 188 and second region 190 are illustrated by dividing line “D”. An operator cab 192 may be arranged within second region 190 of deck 122. Operator cab 192 is configured to house an operator during operation of mining truck 100, along with controls necessary or desired for said operation of mining truck 100.

A resistor grid 194 may be arranged within first region 188 of deck 122 and may be positioned at a generally rearward position of first region 188 of deck 122. A DC/DC system 196 may be positioned on top of resistor grid 194 so that DC/DC system 196 and resistor grid 194 are in a vertically stacked arrangement. An inverter cabinet 198 may be positioned at least partially in first region 188 of deck 122 and at least partially in second region 190 of deck 122. For example, inverter cabinet 198 may be equally positioned in first region 188 and second region 190 or, in some embodiments, be positioned so that a majority of inverter cabinet 198 is in first region 188. In other embodiments, inverter cabinet 198 may be positioned so that a majority of inverter cabinet 198 is in second region 190. As illustrated, inverter cabinet 198 may be positioned within a rear portion of deck 122. The positioning of inverter cabinet 198 in this manner may provide an open area for positioning of additional mining truck components, for example, as described further herein.

Still referring to FIGS. 3-5, mining truck 100 may further include a thermal management system 200. Thermal management system 200 may include a radiator 202 and a DC/DC-battery thermal manager 204. In some embodiments, radiator 202 and DC/DC-battery thermal manager 204 may be integrated, i.e., one thermal management component may serve as both radiator 202 and DC/DC-battery thermal manager 204. In other embodiments, radiator 202 may service both engine 142 and DC/DC system 196, while battery thermal manager 204 only services battery pack module 176. In yet other embodiments, radiator 202 may service engine 142, battery thermal manager 204 may service battery pack module 176, and a third thermal manager or heat exchanger (not shown) may service DC/DC system 196.

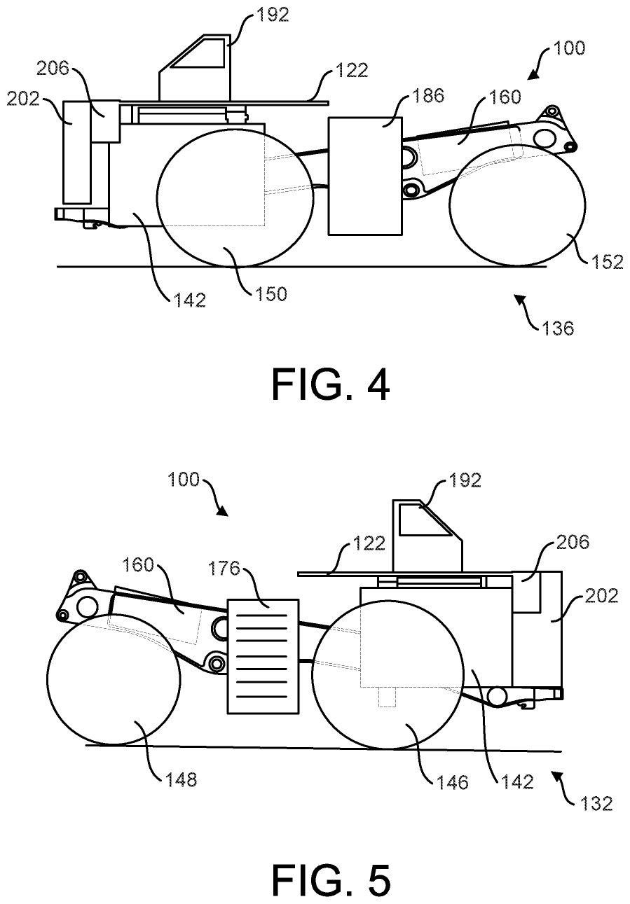

As illustrated, radiator 202 may be mounted to a front of mining truck 100, or, in other words, at a full forward position relative to deck 122. For example, radiator may be mounted at the first end portion of chassis 102 adjacent the first end of chassis 102. In some embodiments, radiator 202 may be, at least in part, mounted to a forward edge of deck 122 so that radiator 202 extends downward from deck 122. In other embodiments, radiator 202 may be mounted to a front of mining truck 100 below deck 122. In yet other embodiments, radiator 202 may be mounted at another position of mining truck 100. Referring specifically to FIGS. 4-5, an air cleaner 206 may be integrated with or positioned immediately adjacent to radiator 202 between radiator 202 and engine 142 to mitigate the presence of dirt, dust, and other contaminants within engine 142, mounted within horse collar 116 of chassis 102.

DC/DC-battery thermal manager 204 may be positioned on deck 122 within first region 188 at a forward position of resistor grid 194 and/or DC/DC system 196. DC/DC-battery thermal manager 204 may be configured to be fluidly coupled to battery pack module 176 to provide coolant or refrigerated liquid to battery pack module 176, and, in some embodiments, may be fluidly coupled to DC/DC system 196 to provide thermal management services to DC/DC system 196.

The arrangement of components on the deck as described herein are exemplary in nature and may be altered within the scope of the disclosure. For example, in some embodiments, first region 188 and second region 190 may be mirrored or switched. In other embodiments, components may be moved relative to one another and/or relative to deck 122. Positioning of the components of the deck as described herein may mitigate damage and/or poor performance from dust, dirt, mud, and/or other environmental considerations. Furthermore, placement of such components on deck 122 in combination with mounting of battery pack module 176, hydraulic liquid tank 184, and second liquid tank 186 in respective side saddles 166, 170 facilitates weight balance of mining truck 100. However, other placements are within the scope of the disclosure.

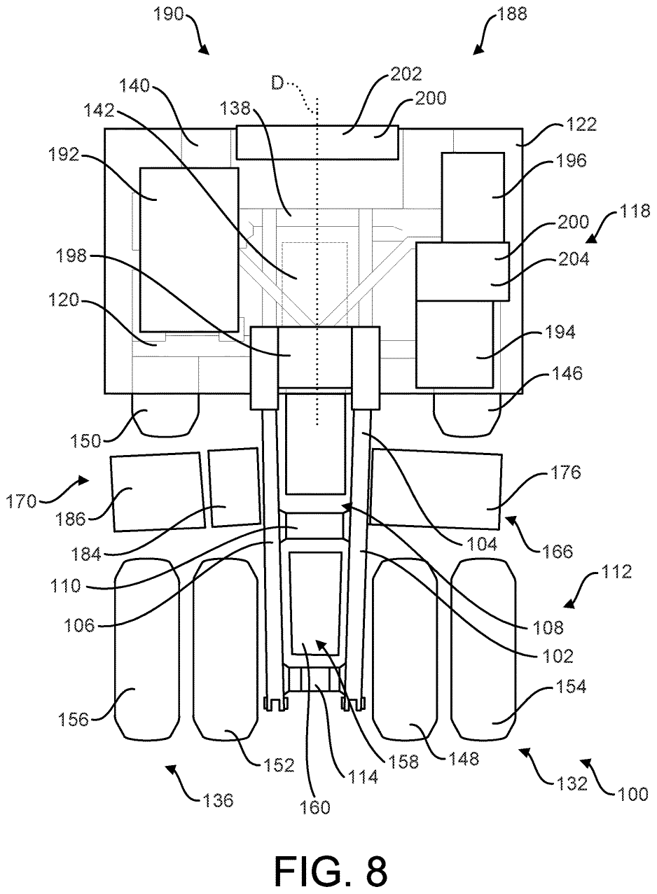

Now referring to FIG. 8, a third exemplary architecture for mining truck 100 is illustrated. Mining truck 100 as illustrated in FIG. 8 includes the same components and details as described in relation to FIGS. 1-5 except as described further herein, with like components associated with like reference numbers.

Resistor grid 194 may be arranged within first region 188 of deck 122 and may be positioned at a generally rearward position of first region 188 of deck 122. DC/DC-battery thermal manager 204 may be positioned forward of resistor grid 194, with DC/DC system 196 positioned forward of DC/DC-battery thermal manager 204, so that DC/DC-battery thermal manager 204 is positioned generally between resistor grid 194 and DC/DC system 196. The positioning of the components herein provides access to service panels on top of resistor grid 194, while further accounting for positioning of DC/DC-battery thermal manager 204 in an efficient position relative to DC/DC system 196 and battery pack module 176 mounted within first side saddle 166.

The arrangement of components as described in relation to FIG. 8 may also mitigate interference with line-of-sight to side mirrors (not shown) of mining truck 100 from operator cab 192 positioned within second region 190 of deck 122. The arrangement of components on the deck as described herein are exemplary in nature and may be altered within the scope of the disclosure. For example, in some embodiments, first region 188 and second region 190 may be mirrored or switched. In other embodiments, components may be moved relative to one another and/or relative to deck 122.

Positioning of the components of the deck as described herein may mitigate damage and/or poor performance from dust, dirt, mud, and/or other environmental considerations. Furthermore, placement of such components on deck 122 in combination with mounting of battery pack module 176, hydraulic liquid tank 184, and second liquid tank 186 in respective side saddles 166, 170 facilitates weight balance of mining truck 100. However, other placements are within the scope of the disclosure.

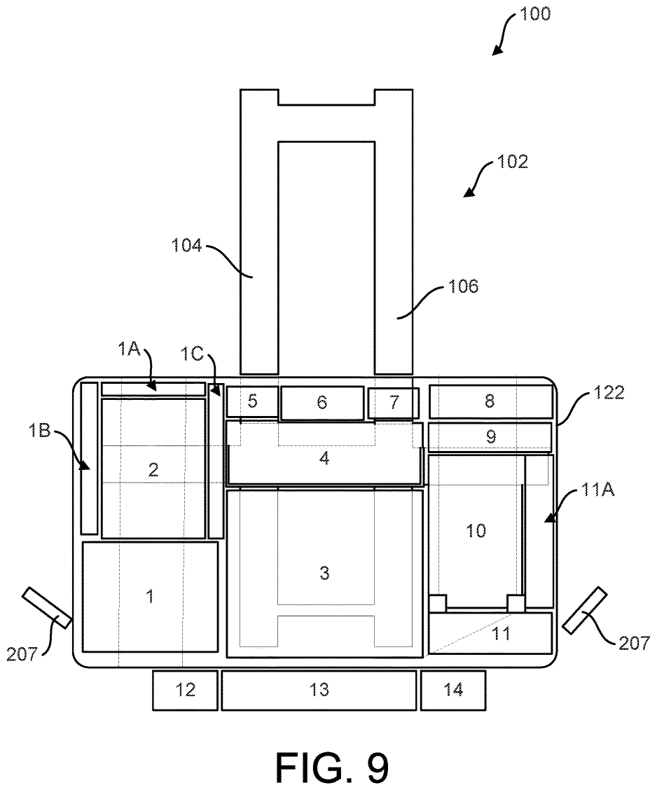

Now referring to FIG. 9, in reference to FIGS. 1-8 above, the positioning of components upon deck 122 of mining truck 100 are further provided in reference to possible requirements of each individual component. In other words, FIG. 9 provides an arrangement of components on deck 122 along with reference to zoned areas for component operation during operation of mining truck 100.

Zone 2 may include a resistor grid, such as resistor grid 194, and may be positioned within first region 188 of deck 122 at a generally rearward portion of deck 122 within first region 188. Space around zone 2 may be defined, for example, within zones 1, and 1a to facilitate grid exhaust of resistor grid 194 and zones 1b and 1c to facilitate air intake for resistor grid 194. In other embodiments described above, wherein DC/DC system 196 and/or DC/DC-battery thermal manager 204 is positioned forward of resistor grid 194, a space may be defined between resistor grid 194 and the other of DC/DC system 196 or DC/DC-battery thermal manager 204 to facilitate grid exhaust of resistor grid 194. In other embodiments, such component may be positioned immediately forward of resistor grid 194, with resistor grid exhaust being otherwise concentrated in zone 1a.

Zone 4 may include an inverter cabinet, such as inverter cabinet 198, containing main electrical systems and controls of mining truck 100, and may be positioned at least partially in first region 188 of deck 122 and at least partially in second region 190 of deck 122. For example, zone 4 may be equally positioned in first region 188 and second region 190 or, in some embodiments, be positioned so that a majority of zone 4 is in first region 188. In other embodiments, zone 4 may be positioned so that a majority of zone 4 is in second region 190. Zone 4 may be spaced apart from zone 2 for at least zone 1c to facilitate air intake for resistor grid 194. Zone 4 may be positioned at the rearmost position of deck 122. In some embodiments, as illustrated, zone 6 may be positioned rearward of zone 4 and include blower ducting to provide main traction blower direction from above inverter cabinet 198. Electrical wiring and blowers may further be positioned within zones 5 and 7. Open space zone 3 may be defined in forward of zone 4 to facilitate access to inverter cabinet 198, operator cab 192 in zone 10, and positioning and access to other components such as a trolley system as described further herein. For example, zone 3 may include pylon scaffolding for connection to upper pylons in embodiments including trolley systems.

Zone 10 may include operator cab 192 and may be arranged within second region 190 of deck 122. Operator cab 192 is configured to house an operator during operation of mining truck 100, along with controls necessary or desired for said operation of mining truck 100. Zones 11 and 11a around zone 10 may remain open to facilitate operator visibility during operation of mining truck 100. For example, zone 11 may facilitate operator visibility forward of mining truck 100. Zone 11a may facilitate operator visibility of rearview mirror 207. Zone 11a may further facilitate operator exit from operator cab 192. As discussed above, zone 3 may also provide access to operator cab 192.

Zone 9 may be positioned rearward of operator cab 10 within second region 190 of deck 122 and include a brake and/or hydraulic cabinet. The brake and/or hydraulic cabinet may provide service and maintenance access to brake and/or hydraulic systems of mining truck 100. Zone 8 may be an open space positioned rearward zone 9 to provide access to the brake and/or hydraulic cabinet. In some embodiments, emergency supplies such as fire extinguishers or other supplies may be stored within zone 8.

Radiator 202 may be mounted to mining truck 100 forward of deck 122 in zone 13. In some embodiments, radiator 202 may be mounted to the forward edge of deck 122. A top surface of radiator 202 may include vents and/or service access to radiator 202. Zones 12 and 14 positioned on either side of zone 13 may serve as emergency or primary exit paths, i.e., paths for exiting mining truck 100 and/or deck 122.

The arrangement of components on the deck as described herein are exemplary in nature and may be altered within the scope of the disclosure. For example, in some embodiments, first region 188 and second region 190 may be mirrored or switched. In other embodiments, components may be moved relative to one another and/or relative to deck 122.

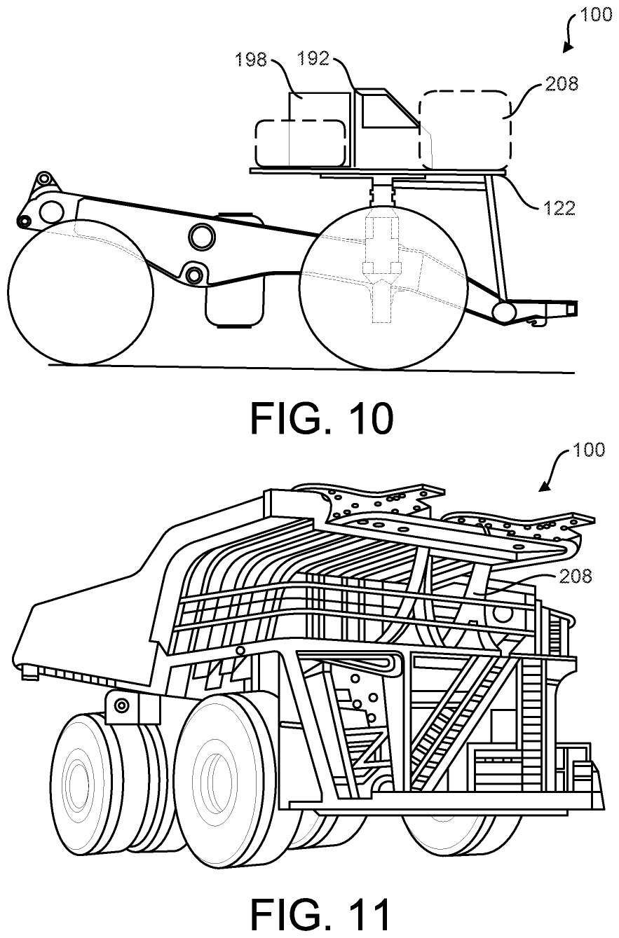

FIGS. 10-11 illustrate an embodiment of mining truck 100 including an on-board trolley system 208, such as a pantograph. As described above, a space forward of inverter cabinet 198 may be defined to receive or may already contain on-board trolley system 208 for connecting to an overhead trolley during operation of mining truck 100. On-board trolley system 208, for example, may facilitate connection of mining truck 100 to an overhead trolley to assist mining truck 100 with traversal of uphill and/or difficult trails or roads and/or when mining truck 100 is carrying heavy loads.

While the system and methods herein have been described by reference to various specific embodiments it should be understood that numerous changes may be made within the spirit and scope of the concepts described, accordingly, it is intended that the invention is not limited to the described embodiments but will have full scope defined by the language of the following claims.

Various aspects are described in this disclosure, which include, but are not limited to, the following aspects:

(1) A mining haul truck, including a chassis; a first wheel coupled to a first side of the chassis at a first forward position; a second wheel coupled to the first side of the chassis at a first rearward position, the first wheel and the second wheel defining a first space therebetween; a third wheel coupled to a second side of the chassis at a second forward position; a fourth wheel coupled to the second side of the chassis at a second rearward position, the third wheel and the fourth wheel defining a second space therebetween; a hydraulic tank coupled to the chassis within the second space; and a fuel tank coupled to the chassis within the second space.

(2) The mining haul truck of Aspect (1), further including a second fuel tank positioned in the second space.

(3) The mining haul truck of Aspect (2), further including a third fuel tank positioned in the first space.

(4) The mining haul truck of Aspect (1), further including a second fuel tank positioned in the first space.

(5) The mining haul truck of Aspect (1), further including a battery pack module coupled to the chassis in the first space.

(6) The mining haul truck of any one of Aspects (1)-(5), wherein the fuel tank contains diesel fuel.

(7) The mining haul truck of any one of Aspects (1)-(6), wherein the hydraulic tank is coupled to the chassis adjacent to the chassis at an interior position and the fuel tank is coupled to the chassis adjacent to the hydraulic tank at an exterior position so that the hydraulic tank is positioned between the chassis and the fuel tank.

(8) A mining haul truck, including: a chassis having a first longitudinal frame member on a first side of the chassis extending from a first end of the chassis to a second end of the chassis and a second longitudinal frame member on a second side of the chassis extending from the first end of the chassis to a second end of the chassis, the first longitudinal frame member and the second longitudinal frame member defining a first space therebetween; a first wheel coupled to a first side of the chassis at a first forward position; a second wheel coupled to the first side of the chassis at a first rearward position, the first wheel and the second wheel defining a second space therebetween; a third wheel coupled to a second side of the chassis at a second forward position; a fourth wheel coupled to the second side of the chassis at a second rearward position, the third wheel and the fourth wheel defining a third space therebetween; an internal combustion engine positioned in the first space; and a battery pack module coupled to the chassis within the second space.

(9) The mining haul truck of Aspect (8), further including at least one fluid tank coupled to the chassis within the third space.

(10) The mining haul truck of Aspect (9), wherein the at least one fluid tank includes a hydraulic tank and a fuel tank.

(11) The mining haul truck of any one of Aspects (8)-(10), wherein the battery pack module is coupled to a thermal management system and a DC/DC system.

(12) The mining haul truck of Aspect (11), wherein the thermal management system and the DC/DC system are supported by the chassis on a forward position thereof.

(13) The mining haul truck of any one of Aspects (8)-(12), wherein the battery pack module and the first wheel define a first clearance area therebetween.

(14) The mining haul truck of any one of Aspects (8)-(13), wherein the battery pack module and the second wheel define a second clearance area therebetween.

(15) The mining haul truck of any one of Aspects (8)-(14), wherein the battery pack module includes a plurality of battery pack layers in a vertical arrangement, each battery pack layer of the plurality of battery pack layers including at least one battery pack.

(16) A mining haul truck, including: a chassis supporting a deck on a forward position thereof; a resistor grid positioned in a first region associated with a first side of the deck; an operator cab positioned in a second region associated with a second side of the deck; a DC/DC system positioned in the first region in a forward position relative to the resistor grid, the DC/DC system and the resistor grid defining a space therebetween; and a thermal management system positioned at least partially in the space.

(17) The mining haul truck of Aspect (16), further including a radiator mounted on a first end portion of the chassis adjacent a first end of the chassis.

(18) The mining haul truck of any one of Aspects (16)-(17), further including an inverter cabinet positioned at a rearward position of the deck.

(19) The mining haul truck of Aspect (18), wherein the inverter cabinet is positioned partially in the first region and partially in the second region.

(20) The mining haul truck of any one of Aspects (16)-(19), wherein the deck defines a space at a forward position configured to receive an on-board trolley system.

(21) The mining haul truck of any one of Aspects (16)-(20), wherein the thermal management system is fluidly coupled to the DC/DC system

(22) A mining haul truck, including: a chassis supporting a deck on a forward portion thereof; a resistor grid positioned in a first region associated with a first side of the deck; an operator cab positioned in a second region associated with a second side of the deck; a DC/DC system positioned on the resistor grid; and a thermal management system positioned at least partially in the first region.

(23) The mining haul truck of Aspect (22), further including a radiator positioned at a full forward position of the deck.

(24) The mining haul truck of any one of Aspects (22)-(23), further including an inverter cabinet positioned at a rearward position of the deck.

(25) The mining haul truck of Aspect (24), wherein the inverter cabinet is positioned partially in the first region and partially in the second region.

(26) The mining haul truck of any one of Aspects (22)-(25), wherein the thermal management system is fluidly coupled to a battery pack module.

(27) The mining haul truck of Aspect (26), wherein the battery pack module is coupled to the chassis between a first wheel and a second wheel.

(28) The mining haul truck of Aspect (27), wherein the first wheel and the second wheel are both positioned on a first side of the chassis.

(29) The mining haul truck of any one of Aspects (22)-(28), wherein the thermal management system is positioned at a forward position relative to the resistor grid.

(30) The mining haul truck of any one of Aspects (22)-(29), wherein the deck defines a space at a forward position configured to receive an on-board trolley system.

(31) A mining haul truck, including: a chassis supporting a deck on a forward portion thereof; a resistor grid and a DC/DC system positioned in a first region associated with a first side of the deck; an operator cab positioned in a second region associated with a second side of the deck; and a floor space of the deck defined partially within the first region and partially within the second region, the floor space configured to receive an on-board trolley system.

(32) The mining haul truck of Aspect (31), wherein the DC/DC system is in a forward position relative to the resistor grid.

(33) The mining haul truck of Aspect (32), wherein the thermal management system is positioned at least partially between the DC/DC system and the resistor grid.

(34) The mining haul truck of any one of Aspects (31), wherein the DC/DC system is positioned on top of the resistor grid.

(35) The mining haul truck of any one of Aspects (31)-(34), further including an inverter cabinet positioned at a rearward position of the deck.

(36) The mining haul truck of Aspect (35), wherein the inverter cabinet is positioned partially in the first region and partially in the second region.

(37) The mining haul truck of any one of Aspects (31)-(36), further including a radiator positioned at a full forward position of the deck.

(38) A mining haul truck, including: a chassis supporting a deck on a forward position thereof, the deck having a first deck side corresponding with a first chassis side and a second deck side corresponding with a second chassis side; a battery pack module coupled to the first chassis side; and a thermal management system at least partially positioned on the first deck side, the thermal management system including a first fluid route to the battery pack module.

(39) The mining haul truck of Aspect (38), further including a hydraulic liquid tank coupled to the second chassis side.

(40) The mining haul truck of Aspect (39), further including a second liquid tank coupled to the second chassis side.

(41) The mining haul truck of Aspect (40), wherein the second liquid tank is a fuel tank.

(42) The mining haul truck of any one of Aspects (38)-(41), further including a DC/DC system positioned on the first deck side.

(43) The mining haul truck of Aspect (42), wherein the thermal management system includes a second fluid route to the DC/DC system.

(44) The mining haul truck of any one of Aspects (42)-(43), wherein the thermal management system is in a rearward position relative to the DC/DC system.

(45) The mining haul truck of any one of Aspects (43)-(44), further including a resistor grid in a rearward position relative to the DC/DC system.

(46) The mining haul truck of any one of Aspects (43)-(44), further including a resistor grid positioned beneath the DC/DC system.

(47) The mining haul truck of any one of Aspects (38)-(46), further including a radiator positioned at a full forward position of the deck.

(48) The mining haul truck of any one of Aspects (38)-(47), wherein the deck defines a space at a forward position configured to receive an on-board trolley system.

(49) A method of assembling a mining haul truck having a chassis, a first wheel and a second wheel mounted to a first side of the chassis, and a third wheel and a fourth wheel mounted to a second side of the chassis, the method including: mounting a hydraulic liquid tank to the chassis at a first position between the first wheel and the second wheel; and mounting a second liquid tank to the chassis at a second position between the first wheel and the second wheel.

(50) The method of Aspect (49), wherein the second liquid tank is a fuel tank.

(51) The method of any one of Aspects (49)-(50), further including mounting a third liquid tank to the chassis at a third position between the third wheel and the fourth wheel.

(52) The method of any one of Aspects (49)-(51), further including mounting a vehicle subsystem at a third position between the second wheel and the fourth wheel.

(53) The method of Aspect (52), wherein the vehicle subsystem is at least one of an aftertreatment system and an exhaust muffler.

(54) The method of any one of Aspects (49)-(53), wherein the hydraulic liquid tank is mounted to the chassis between the chassis and the second liquid tank.

(55) A method of assembling a mining haul truck having a chassis, a first wheel and a second wheel mounted to a first side of the chassis, and a third wheel and a fourth wheel mounted to a second side of the chassis, the method including: mounting a hydraulic tank to the chassis at a first position between the first wheel and the second wheel; and mounting a battery pack module to the chassis at a second position between the third wheel and the fourth wheel.

(56) The method of Aspect (55), further including mounting a second liquid tank to the chassis at a third position between the first wheel and the second wheel.

(57) The method of any one of Aspects (55)-(56), further including coupling the battery pack module to a thermal management system and a DC/DC system.

(58) The method of Aspect (57), wherein the thermal management system and the DC/DC system are supported by a deck, the deck supported by the chassis on a forward position thereof.

(59) The method of any one of Aspects (55)-(58), further including mounting a vehicle subsystem between the second wheel and the fourth wheel.

(60) The method of Aspect (59), wherein the vehicle subsystem is an aftertreatment system.

(61) A method of assembling a mining haul truck having a chassis, a deck supported by a forward portion of the chassis, a first wheel and a second wheel mounted to a first side of the chassis, and a third wheel and a fourth wheel mounted to a second side of the chassis, the method including: mounting a resistor grid on the deck at a first position; and mounting a thermal management system on the deck at a second position forward of the resistor grid.

(62) The method of Aspect (61), further including mounting a DC/DC system in a forward position relative to the resistor grid.

(63) The method of Aspect (62), wherein mounting the DC/DC system in the forward position relative to the resistor grid includes mounting the DC/DC system in a forward position relative to the thermal management system.

(64) The method of Aspect (61), further including mounting a DC/DC system on top of the resistor grid.

(65) The method of any one of Aspects (61)-(64), further including fluidly coupling the thermal management system to a battery pack module.

(66) The method of Aspect (65), further including mounting the battery pack module to the chassis at a first position between the first wheel and the second wheel.

(67) The method of any one of Aspects (61)-(66), further including mounting an on-board trolley system to the deck.

What is claimed is:

1. A mining haul truck, comprising:
a chassis;
a first wheel coupled to a first side of the chassis at a first forward position;
a second wheel coupled to the first side of the chassis at a first rearward position, the first wheel and the second wheel defining a first space therebetween;
a third wheel coupled to a second side of the chassis at a second forward position;
a fourth wheel coupled to the second side of the chassis at a second rearward position, the third wheel and the fourth wheel defining a second space therebetween;
a hydraulic tank coupled to the chassis within the second space; and
a fuel tank coupled to the chassis within the second space.

2. The mining haul truck of claim 1, further comprising a second fuel tank positioned in the second space.

3. The mining haul truck of claim 2, further comprising a third fuel tank positioned in the first space.

4. The mining haul truck of claim 1, further comprising a second fuel tank positioned in the first space.

5. The mining haul truck of claim 1, further comprising a battery pack module coupled to the chassis in the first space.

6. The mining haul truck of any one of claims 1, wherein the hydraulic tank is coupled to the chassis adjacent to the chassis at an interior position and the fuel tank is coupled to the chassis adjacent to the hydraulic tank at an exterior position so that the hydraulic tank is positioned between the chassis and the fuel tank.

7. A mining haul truck, comprising:
a chassis having a first longitudinal frame member on a first side of the chassis extending from a first end of the chassis to a second end of the chassis and a second longitudinal frame member on a second side of the chassis extending from the first end of the chassis to a second end of the chassis, the first longitudinal frame member and the second longitudinal frame member defining a first space therebetween;
a first wheel coupled to a first side of the chassis at a first forward position;
a second wheel coupled to the first side of the chassis at a first rearward position, the first wheel and the second wheel defining a second space therebetween;
a third wheel coupled to a second side of the chassis at a second forward position;
a fourth wheel coupled to the second side of the chassis at a second rearward position, the third wheel and the fourth wheel defining a third space therebetween;
an internal combustion engine positioned in the first space; and
a battery pack module coupled to the chassis within the second space.

8. The mining haul truck of claim 7, further comprising at least one fluid tank coupled to the chassis within the third space.

9. The mining haul truck of claim 8, wherein the at least one fluid tank comprises a hydraulic tank and a fuel tank.

10. The mining haul truck of any one of claims 7, wherein the battery pack module is coupled to a thermal management system and a DC/DC system.

11. The mining haul truck of claim 10, wherein the thermal management system and the DC/DC system are supported by the chassis on a forward position thereof.

12. The mining haul truck of any one of claims 7, wherein the battery pack module and the first wheel define a first clearance area therebetween.

13. The mining haul truck of any one of claims 7, wherein the battery pack module and the second wheel define a second clearance area therebetween.

14. The mining haul truck of any one of claims 7, wherein the battery pack module includes a plurality of battery pack layers in a vertical arrangement, each battery pack layer of the plurality of battery pack layers including at least one battery pack.

15. A mining haul truck, comprising:
a chassis supporting a deck on a forward position thereof;
a resistor grid positioned in a first region associated with a first side of the deck;
an operator cab positioned in a second region associated with a second side of the deck;
a DC/DC system positioned in the first region in a forward position relative to the resistor grid, the DC/DC system and the resistor grid defining a space therebetween; and
a thermal management system positioned at least partially in the space.

16. The mining haul truck of claim 15, further comprising a radiator mounted at a first end portion of the chassis adjacent a first end of the chassis.

17. The mining haul truck of any one of claims 15, further comprising an inverter cabinet positioned at a rearward position of the deck.

18. The mining haul truck of claim 17, wherein the inverter cabinet is positioned partially in the first region and partially in the second region.

19. The mining haul truck of any one of claims 15, wherein the deck defines a space at a forward position configured to receive an on-board trolley system.

20. The mining haul truck of any one of claims 15, wherein the thermal management system is fluidly coupled to the DC/DC system.
